(19) United States
(12) Patent Application Publication
(10) Pub. No.: US 2003/0091109 A1
(43) Pub. Date: May 15, 2003

(54) Convolution interleaver and deinterleaver for systems with error correction encoding

(76) Inventors: Yuri Okunev, Southbury, CT (US); Yuri Goldstein, Southbury, CT (US)

Correspondence Address: David P. Gordon, Esq., 65 Woods End Road, Stamford, CT, 06905, US

(21) Appl. No.: 09/981,382

(22) Filed: Oct. 16, 2001

(51) Int. Cl. H04L 5/16; H04B 1/38

(52) U.S. Cl. 375/222

(57) ABSTRACT

An interleaver for a digital modem is provided where consecutive codeword symbols are written in parallel into first cells of registers. Reading from registers for-interleaving purposes is dictated by a permutation table containing N−1 numbers which represent registers from which the current symbol should be read. Prior to data transmission, a calculation is made of lengths of the registers and a permutation table is determined. During data transmission, the first symbol in each codeword is sent directly to the output, the other symbols are sequentially written into the first cells of the corresponding registers, and the last cells of the registers are sequentially read in the order determined by the permutation table. After writing the incoming codeword into memory and reading the outgoing codeword, the contents of all memory registers are synchronously shifted by one cell in the output direction. A corresponding deinterleaver is also provided.

### BACKGROUND

1. Field of the Invention

The present invention relates to telecommunications apparatus, systems and methods. More particularly, the present invention relates to convolutional interleavers and deinterleavers of digital modems and transceivers. The invention has particular application to digital subscriber line (DSL) and wireless systems, although it is not limited thereto.

2. State of the Art

In data communications systems, noisy transmission lines can cause data to be corrupted or lost. In order to prevent data loss it is well known to transmit error-checking data along with the transmitted (payload) data. The combination of the payload data and the error-checking data for the payload is often referred to as a codeword. The receiving end of the data transmission can determine if errors have occurred in a particular codeword based on the payload data and error-checking data received. If the amount of error or loss in a codeword is relatively small, the error-checking data can be used to recover the correct payload data.

Bursts of noise on the transmission medium may cause the data corruption in a codeword to be sufficiently severe such that recovery is not possible. In order to reduce the impact of these bursts of noise, data interleaving techniques are often employed. By interleaving data from different codewords before data transmission and deinterleaving the received data at the receiver, the impact of a burst of noise is spread over a number of different codewords thereby reducing the loss of each codeword to a level where recovery of the payload data in each codeword is possible.

Well known convolutional interleavers which are used, for example, in ADSL systems, distribute incoming symbols of a codeword according to

dL(i)=(D−1)*i, i=0,1,2, . . . ,(N−1) (1)

where dL(i) is the delay of the i'th symbol of a codeword, D is the interleaving depth, and N is the codeword length. Direct implementation of this algorithm in a shift register requires a large memory because the memory size must accommodate the maximum required delay (max dL(i)). The required memory size mₛ is defined by:

mₛ=max dL(i)=(D−1)*(N−1) (2)

It will be appreciated by those skilled in the art that the memory size can result in a considerable implementation problem when N and D are large. For example, when using a Reed-Solomon code with codeword length N=255 and interleaving depth D=64, memories of 16,002 8-bit memory cells are required for implementation of the interleaver and deinterleaver. In integrated circuit implementation, large memory blocks require large amounts of “real estate”, thereby adding to the cost of the system. Thus, it is desirable to decrease the amount of memory required for implementation of the interleaver and deinterleaver of the system.

In developing interleaving and deinterleaving algorithms which require less memory, it is useful to determine the minimum number of memory cells required for interleaver and deinterleaver implementation. In finding the minimum number of cells required, it may be assumed that every incoming symbol is written into the cell that is released by reading a current outgoing symbol.

Using the first memory cell (MC) to delay (store) the second incoming symbol of the codeword, and adding one more MC every time there is not an empty MC among the MCs which have been already taken, the number of MCs required increases up to a minimum number mₘᵢₙ. The minimum mₘᵢₙ is the necessary and sufficient number of memory cells required to implement interleaving and is less than mₛ.

The number mₘᵢₙ is equal to the number of incoming symbols which have come before the mₛ'th incoming symbol, but which, on the other hand should be transmitted during or after the mₛ'th incoming symbol. In other words, mₘᵢₙ is equal to a number of incoming symbols with indexes n≧0, and n≦[(N−1)*(D−1)−1], which satisfy the inequality

n+(D−1)*r≧(D−1)*(N−1) (3)

where

r=n−(N*q); q=floor(n/N) (4)

Computer simulation of this algorithm has shown that a number of indexes satisfying inequality (3) is approximately equal to

mₘᵢₙ≈(D−1)*(N−1)/2 (5)

Thus, it is seen that the necessary and sufficient number of memory cells for implementing an interleaver is approximately half the number utilized for a standard shift register implementation.

An interleaver/deinterleaver algorithm which can be implemented with a number of memory cells close to mₘᵢₙ is disclosed in U.S. Pat. No. 5,636,224 to Voith et al., entitled “Method and Apparatus for Interleave/De-Interleave Addressing in Data Communication Circuits” which is hereby incorporated by reference herein in its entirety. The Voith et al. algorithm uses parallel circular buffers or FIFOs. The algorithm uses N−1 subsets of memory cells (registers), and symbols of a code word are written into separate registers. In reading symbols from registers of the transmitter and writing symbols to registers of the receiver, the Voith et al. algorithm requires computations which include the solving of some specific equation. These computations must be done “on the fly”, and therefore require significant computational power. Thus, the Voith et al. algorithm trades off a decrease in memory requirements for an increase in computational power and as a result does not necessarily reduce the expense of the system significantly.

### SUMMARY OF THE INVENTION

It is therefore an object of the invention to provide an interleaver/deinterleaver which can read/write symbols from/to memory registers without current computations.

It is another object of the invention to provide an interleaver/deinterleaver which requires a memory which is not much larger than the minimum required.

It is a further object of the invention to generate a permutation table which is generated based on a simple computation algorithm.

In accord with the objects of the invention, an interleaver for a digital modem is provided where consecutive codeword symbols are written into first cells of parallel registers, and reading from registers for interleaving purposes is determined by a permutation table (register) containing N−1 numbers calculated prior to data transmission. The permutation table contains a sequence of N−1 numbers where each number is an index of a register from which the current symbol should be read.

According to the method of the invention, prior to data transmission, a calculation is made of lengths of the registers (i.e., how many cells each register must have), and a permutation table is determined. Then, during data transmission, the first symbol in each code word is sent directly to the output, the other symbols are sequentially written into the first (input) cells of the corresponding registers, and at the same time, the last (output) cells of the registers are sequentially read in the order determined by the permutation table. After writing the incoming codeword into memory and reading the outgoing codeword, the contents of all memory registers are synchronously shifted by one cell in the output direction.

A deinterleaver according to the invention corresponds closely to the interleaver of the invention.

Additional objects and advantages of the invention will become apparent to those skilled in the art upon reference to the detailed description taken in conjunction with the provided figures.

### BRIEF DESCRIPTION OF THE DRAWINGS

FIG. 1 is a high-level flow/block diagram of a DSL modem;

FIG. 2 is a high-level block/flow diagram of the interleaving and deinterleaving mechanism of the invention;

FIG. 3 is a chart illustrating an interleaving algorithm example of the invention; and

FIG. 4 is a chart illustration a deinterleaving algorithm example of the invention.

FIGS. 5a and 5b are flow charts representing the method of the invention.

### DETAILED DESCRIPTION OF THE PREFERRED EMBODIMENT

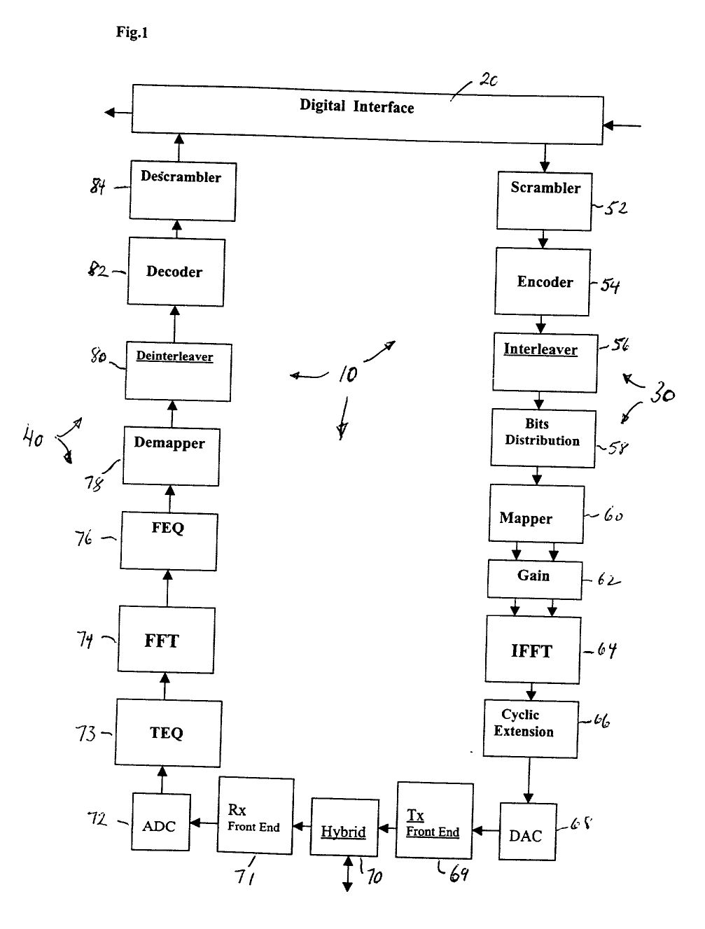

The present invention is best understood with reference to a DSL-type modem. Turning to FIG. 1, a high level block diagram of a DSL modem 10 is seen. The modem 10 preferably includes a digital interface 20, a transmitter section 30 and a receiver section 40. The transmitter section preferably includes a scrambler 52 which receives data from the digital interface 20, a Reed-Solomon encoder 54, an interleaver 56, a per-carrier bit distributor 58, a mapper 60, a gain element 62, an inverse fast Fourier transform block (IFFT) 64, a cyclic extension block 66, a digital to analog converter 68 and an analog front end transmit block 69 which interfaces with a hybrid 70. The receiver section preferably includes an analog front end receive block 71 which interfaces with the hybrid 70, an analog to digital converter 72, a time equalizer (TEQ) 73, a fast Fourier transform block (FFT) 74, a frequency equalizer (FEQ) 76, a demapper 78, a deinterleaver 80, a Reed-Solomon decoder 82, and a descrambler 84 which provides data to the digital interface 20. Other than the details of the interleaver 56 and deinterleaver 80, the modem 10 is substantially as would be understood by those skilled in the art. In addition, it will be appreciated by those skilled in the art that the modem 10 may be implemented in hardware, software, or a combination thereof.

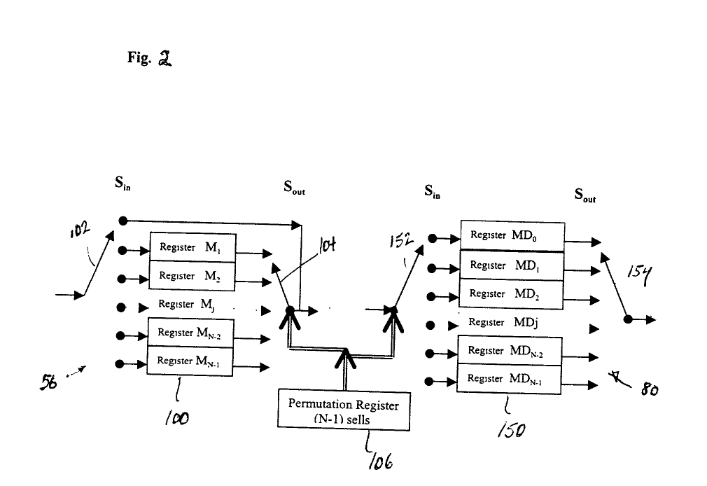

Turning now to FIG. 2, the interleaver 56 and deinterleaver 80 of the invention are seen in high level format. In particular, the interleaver 56 includes a plurality of parallel registers 100 labeled M₁, M₂, . . . , M_{N-2}, M_{N-1}, means 102 for writing symbols into the registers, and means 104 for reading symbols out of the registers 100 according to a permutation table stored in a permutation register 106. The deinterleaver 80 includes a plurality of parallel registers 150 labeled MD₀, MD₁, MD₂, . . . , MD_{N-2}, M_{N-1}, means 152 for writing symbols into the registers according to the permutation table stored in a permutation register 106, and means 154 for reading symbols out of the registers 150.

The permutation table is generated according to a permutation algorithm which includes, prior to data transmission, calculating the lengths of the registers 100 (and 150) and calculating the permutation table. During data transmission, the inputs and outputs of the registers 100 and 150 are switched according to the permutation table. The permutation table contains a sequence of N−1 numbers (from 1 to N−1), with each number being an index of a register from which the current symbol should be read (in the interleaver) or an index of a register to which the current symbol should be written (in the deinterleaver).

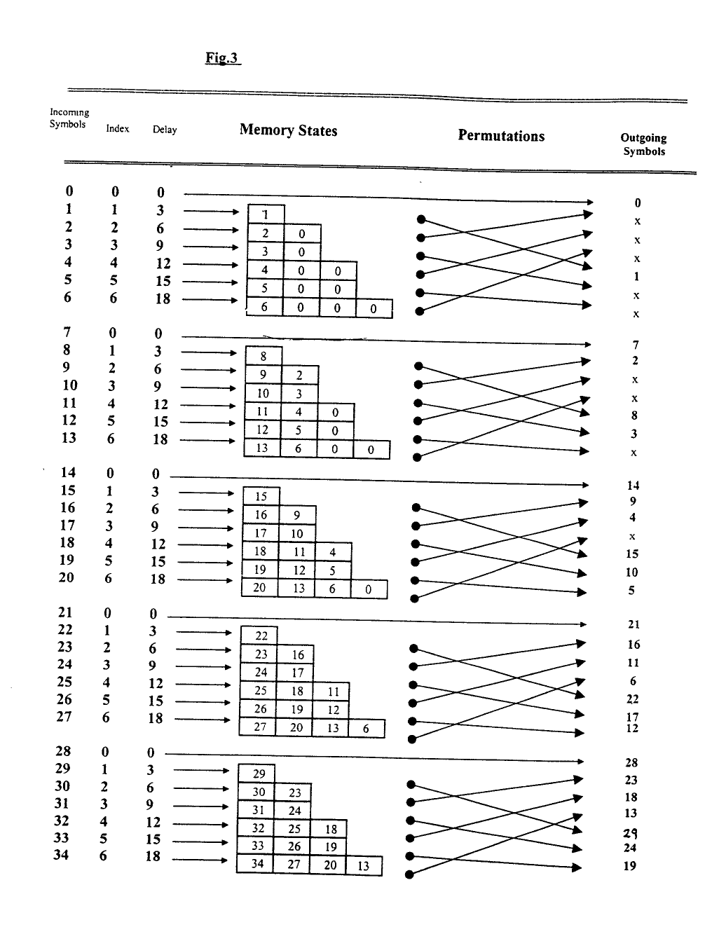

FIG. 3 illustrates an example of the interleaving algorithm where the codeword length N=7, and the interleaving depth D=4. The first three columns in FIG. 3 represent parameters of symbols which are to be interleaved (the “incoming” symbols), with the first column containing the ordinal numbers (indexes) of the symbols, the second column containing the ordinal numbers of the same symbols within a codeword, and the third column representing symbol delays. The last column of FIG. 3 represents indexes of the outgoing symbols; i.e., the interleaved signals which are being currently transmitted. The “memory states” and “permutations” columns of FIG. 3 demonstrate how the incoming symbols are transformed into the outgoing symbols (for transmission). More particularly, when the first codeword of seven symbols is received, the first symbol (byte 0) is used as the first symbol of the interleaved outgoing signal, and the second through seventh symbols (symbols 1-6) are placed into the first cells of registers M₁ through M₆. As will be appreciated by those skilled in the art, because symbol 1 is delayed by only three symbols, it appears as the fifth symbol in the first outgoing word; while, because symbols 2-6 are delayed six, nine, twelve, fifteen, and eighteen symbols respectively, they appear in the second, third, and fourth outgoing words. Thus, the first outgoing codeword contains incoming symbols 0 and 1, and five additional symbols (bytes) of stuff (denoted by “x”).

When the second incoming codeword is received, the first symbol (incoming symbol 7) is used as the first symbol of the interleaved outgoing codeword. The second through seventh symbols (symbols 8-13) are placed into registers M₁ through M₆. Symbol 8 is placed into the first and only cell of register M₁ (which is “empty” because symbol 1 which had previously occupied that cell, was written into the first outgoing codeword). Symbols 9-13 are placed into the first cells of registers M₂ through M₆, the contents of those cells being shifted into the next cells of those registers. The second outgoing codeword is then generated using symbol 7 as the first symbol of that codeword, symbol 2 as the second symbol (symbol 2 having been delayed six symbols), symbol 8 as the fifth symbol (symbol 8 having been delayed three symbols), and symbol 3 as the sixth symbol (symbol 3 having been delayed nine symbols). Three additional symbols of stuff are inserted into the third, fourth, and seventh symbol locations of the second codeword.

When the third incoming codeword is received, the first sybmol (incoming symbol 14) is used as the first symbol of the interleaved outgoing codeword. The second through seventh symbols (symbols 15-20) are placed into registers M₁ through M₆. Symbol 15 is placed into the first and only cell of register M₁ (which is “empty” because symbol 8 which had previously occupied that cell, was written into the second outgoing codeword). Symbols 15-20 are placed into the first cells of registers M₂ through M₆, the contents of those cells being shifted into the next cells of those registers (with the content of the second cells, being shifted into the third cells in the cases of M₄ through N₆). The third outgoing codeword is then generated using symbol 14 as the first symbol of that codeword, symbol 9 as the second symbol (symbol 9 having been delayed six symbols), symbol 4 as the third symbol (symbol 4 having been delayed twelve symbols), symbol 15 as the fifth symbol (symbol 15 having been delayed three symbols), symbol 10 as the sixth symbol (symbol 10 having been delayed nine symbols), and symbol 5 as the seventh symbol (symbol 5 having been delayed fifteen symbols). An additional symbol of stuff is inserted into the fourth byte location of the third codeword.

When the fourth incoming codeword is received, the first symbol (incoming symbol 21) is used as the first symbol of the interleaved outgoing codeword. The second through seventh symbols (symbols 22-27) are placed into registers M₁ through M₆. Symbol 22 is placed into the first and only cell of register M₁ (which is “empty” because symbol 15 which had previously occupied that cell, was written into the third outgoing codeword). Symbols 22-27 are placed into the first cells of registers M₂ through M₆, the contents of those cells being shifted into the next cells of those registers (with the content of the second cells, in the case of M₄ and M₅, being shifted into the third cells, and the content of the third cell, in the case of M₆, being shifted into a fourth cell). The fourth outgoing codeword is then generated using symbol 21 as the first symbol of that codeword, symbol 16 as the second symbol (symbol 16 having been delayed six symbols), symbol 11 as the third symbol (symbol 11 having been delayed twelve symbols), symbol 6 as the fourth symbol (symbol 6 having been delayed eighteen symbols), symbol 22 as the fifth symbol (symbol 22 having been delayed three symbols), symbol 17 as the sixth symbol (symbol 17 having been delayed nine symbols), and symbol 12 as the seventh symbol (symbol 12 having been delayed fifteen symbols).

When the fifth incoming codeword is received, the process is repeated as indicated. No additional cells are required in registers M₁ through M₆ as the contents contained in one of the cells of each of the registers was written into the previous outgoing codeword. Thus, it should be appreciated that in the case of the interleaving algorithm where N=7, and D=4, six registers are required, with the first register containing only a single cell, the second and third registers containing two cells, the fourth and fifth registers containing three cells, and the sixth register containing four cells. The number of cells in each of the registers is calculated in advance and is not changed during data transmission. In addition, the order from which the last of the cells of each of the registers is sequentially read is repetitive (as seen by comparing the groups of arrows of the permutation column of FIG. 3 with respect to each codeword) and therefore may be predicted according to a permutation table:

TABLE 1
Interleaver permutation table for N = 7, D = 4

| | | | | | | | |
|---|---|---|---|---|---|---|---|
| Byte of | 0 | 1 | 2 | 3 | 4 | 5 | 6 |
| outgoing | | | | | | | |
| codeword | | | | | | | |
| Register | Taken | 2 | 4 | 6 | 1 | 3 | 5 |
| byte is | directly | | | | | | |
| taken from | | | | | | | |

Thus, the first symbol of every outgoing codeword is taken from the first incoming symbol directly; the second symbol of the outgoing codeword is taken from the second cell of the second register M₂ (having been delayed six symbols); the third symbol of the outgoing codeword is taken from the third cell of the fourth register M₄ (having been delayed twelve symbols); the fourth symbol of the outgoing codeword is taken from the fourth cell of the sixth register M₆ (having been delayed eighteen symbols); the fifth symbol of the outgoing codeword is taken from the first and only cell of the first register M₁ (having been delayed three symbols); the sixth symbol of the outgoing codeword is taken from the second cell of the third register M₃ (having been delayed nine symbols); and the seventh symbol of the outgoing codeword is taken from the third cell of the fifth register M₅ (having been delayed fifteen symbols).

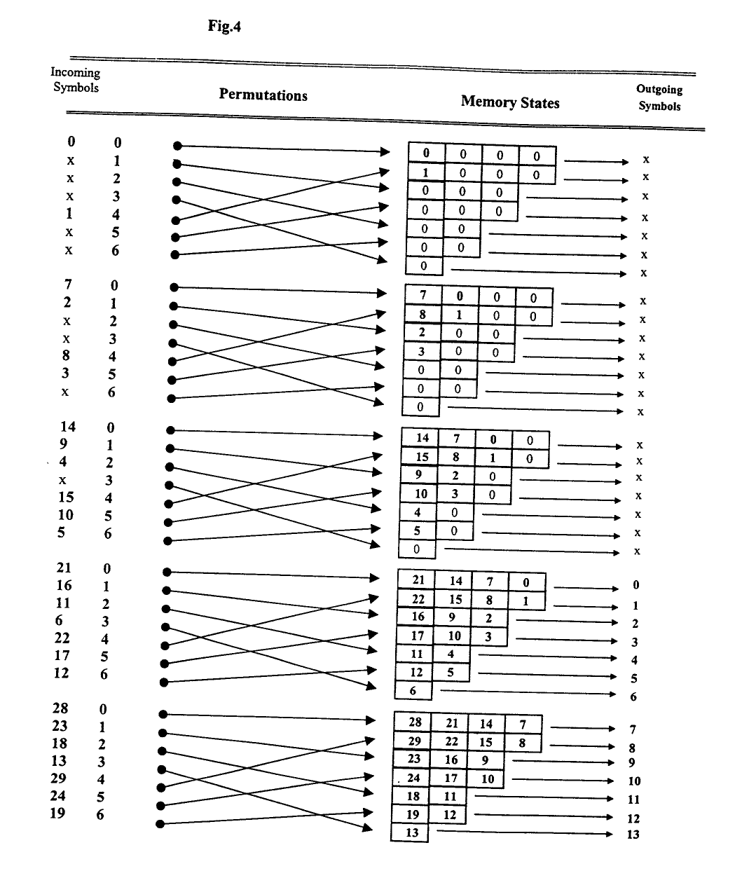

Once the interleaver permutation table is set, the deinterleaver permutation table is effectively determined. In particular, and as seen in FIG. 4, the symbols of the incoming codeword on the deinterleaving side are distributed to seven parallel registers in an inverse manner according to the following deinterleaver table.

TABLE 2
Deinterleaver permutation table for N = 7, D = 4

| | | | | | | | |
|---|---|---|---|---|---|---|---|
| Byte of | 0 | 1 | 2 | 3 | 4 | 5 | 6 |
| interleaved | | | | | | | |
| incoming | | | | | | | |
| codeword | | | | | | | |
| Register to | 0 | 2 | 4 | 6 | 1 | 3 | 5 |
| which byte | | | | | | | |
| is directed | | | | | | | |

Thus, symbol 0 is forwarded to register MD₀; symbol 1 is forwarded to register MD₂; symbol 2 is forwarded to register MD₄; symbol 3 is forwarded to register MD₆; symbol 4 is forwarded to register MD₁; symbol 5 is forwarded to register MD₃; and symbol 6 is forwarded to register MD₅. The registers MD₀ through MD₆ are likewise provided with different numbers of cells depending upon how long bytes must be stored before an entire codeword can be reconstructed. As seen in the memory states column of FIG. 4, the number of cells for registers MD₁ through MD₆ is essentially the reverse of the number of cells for registers M₁ through M₆ of the interleaver, and the extra register (M₀) is provided with four cells.

With the register structure provided, and utilizing the deinterleaving table, the codewords are regenerated by taking the symbols located in the last cells of each of the registers in order. As shown in FIG. 4, with N=7 and D=4, the first regenerated symbol occurs after receiving the fourth incoming codeword. Thereafter, all cells of all seven registers are utilized with symbols being written into the first cells of each of the registers, and symbols already sitting in cells either being shifted into adjacent cells or being written out to regenerate a codeword.

Because the interleaver and deinterleaver use a simple table, complex computations are not required to implement them. In addition, the interleaver and deinterleaver of the invention do not require memories which are significantly larger than the minimum required. In fact, in the general case (for odd N, and any value for D), the total number of interleaver memory cells m_{I} is equal to

m_{I}=(N−1)*[((D−1)/2)+1)] (6)

which is close to the minimum mₘᵢₙ and almost two time less than mₛ. If N=255 and D=64, then m_{I}=8255, mₘᵢₙ=8001, and mₛ=16002. Similarly, the total number of interleaver memory cells m_{D}=m_{I}+D. Thus, for the same example where N=255 and D=64, m_{D}=8319.

Given all of the above, methods of interleaving and deinterleaving according to the invention can be described according to initialization steps and processing steps. The steps utilize the following designations:

D—interleaving depth;

N—code word length;

Mⱼ—j'th interleaver register;

Lⱼ—j'th interleaver register length;

MDⱼ—j'th deinterleaver register;

LDⱼ—j'th deinterleaver register length;

P—permutation register with length N−1;

Sᵢₙ(i)—i'th incoming symbol of a codeword;

ceil—rounding up to the next whole number;

floor—rounding down to the next whole number.

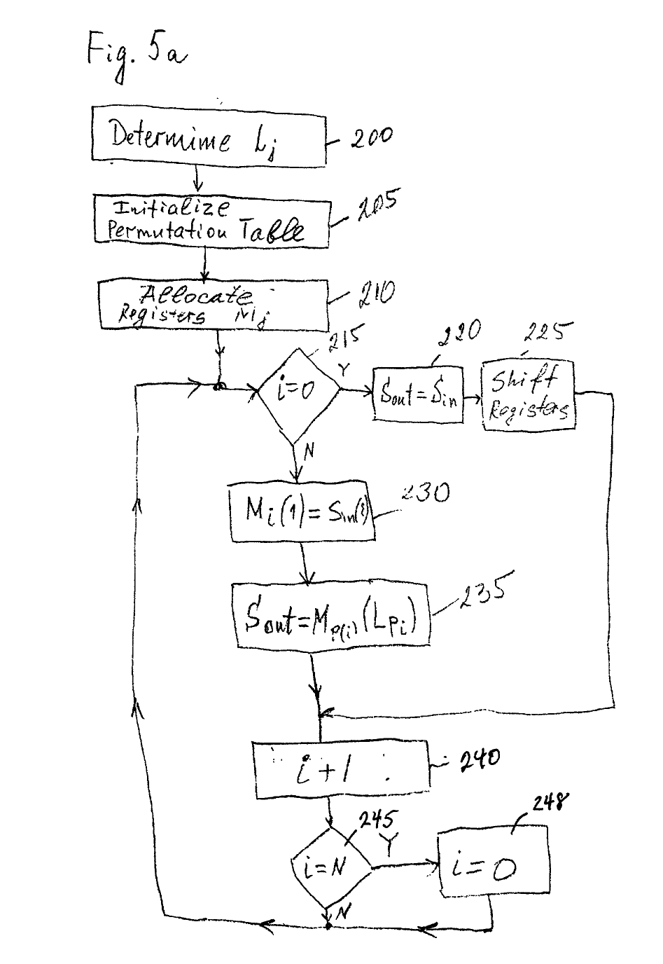

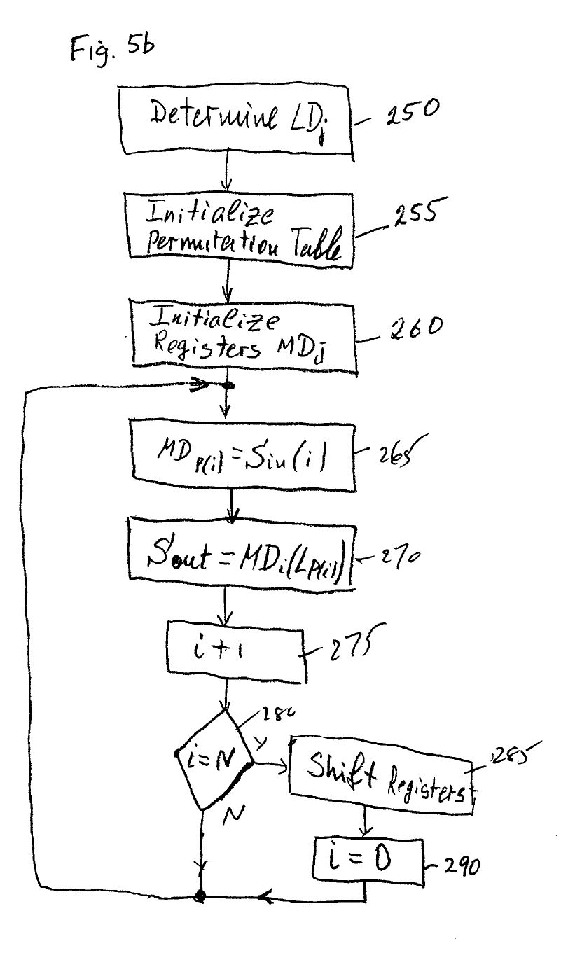

Referring now to FIG. 5a, according to a method of the invention, in a first initialization step for interleaving, the length Lⱼ of the j'th register Mⱼ is determined at 200 according to:

Lⱼ=ceil(j*D/N), j=1,2, . . . , (N−1) (7)

In a second initialization step for interleaving, at 205, a permutation register holding indications of the interleaving permutation table is initialized. Initialization can be represented by calculating

f(n)=n_{ModN} (8)

k(n)=(D−1)*f(n)+n (9)

m(n)=k(n)−N*(D−1) (10)

where n=0,1,2, . . . , (N*D−1) and by setting indication f(n) into the m(n)'th cell of the permutation register P when N*D>k(n)>N*(D−1).

Initialization may also be represented by the following code:

for n=0 : 1 : (N*D − 1)

f=n-N*floor (n/N);
k=(D−1)*f + n;
if k>N*(D−1) and k<N*D

m=k−N* (D−1);
P(m) = f;

end

end

The results of the above code for N=7 and D=4 are illustrated in Appendix 1 below:

[image]

[image]

[image]

[image]

[image]

[image]

[image]

[image]

[image]

[image]

[image]

What is claimed is:

1. A modem, comprising:
a) a digital interface;
b) a receiver coupled to said digital interface; and
c) a transmitter coupled to said digital interface, said transmitter including an interleaver which receives incoming codewords having a plurality of symbols and a given length, wherein
said interleaver distributes said symbols according to
dL(i)=(D−1)*i, i=0,1,2, . . . ,(N−1),
where dL(i) is the delay of the i'th symbol of a codeword, D is the interleaving depth, and N is said given length, and wherein
said interleaver includes N−1 registers for storing symbols of an incoming codeword in parallel, a plurality of said N−1 registers including a plurality of cells with each cell storing a symbol, and said interleaver further including a permutation register for storing indications of a static order in which symbols are either written into or read out from said plurality of registers in order to generate an interleaved outgoing codeword.

2. A modem according to claim 1, wherein:
said permutation register includes N−1 cells.

3. A modem according to claim 1, wherein:
each said outgoing codeword has N sequential symbols, and a first of said N sequential symbols is taken from a first symbol of said incoming codeword.

4. A modem according to claim 1, wherein:
each of said symbols is a byte.

5. A modem according to claim 1, wherein:
N is an odd number greater than five, and at least one of said plurality of N−1 registers has a single cell, at least one of said plurality of N−1 registers has two cells, and at least one of said plurality of N−1 registers has three cells.

6. A modem according to claim 5, wherein:
the length Lⱼ of the j'th register of said N−1 registers is determined according to
Lⱼ=ceil(j*D/N), j=1,2, . . . ,(N−1)
where ceil is a rounding-up to the next higher integer indication.

7. A modem according to claim 1, wherein:
said indications of said permutation register are set according to a code comprising
for n=0 : 1 : (N*D − 1)
f=n-N*floor (n/N);
k=(D−1) *f + n;
if k>N* (D−1) and k<N*D
m=k-N* (D−1);
P(m) = f;
end
end
where
P is said permutation register, and floor is a rounding down to the next whole number indication.

8. A modem according to claim 1, wherein:
said indications of said permutation register are set according to
f(n)=n_{ModN},
k(n)=(D−1)*f(n)+n,
m(n)=k(n)−N*(D−1),
where n=0,1,2, . . . ,(N*D−1), and Mod represents a modulus determination, and by setting indication f(n) into the m(n)'th cell of said permutation register when N*D>k(n)>N*(D−1).

9. A modem according to claim 1, wherein:
said plurality of said N−1 registers uses a total number of interleaver memory cells m_{I}=(N−1)*[((D−1)/2)+1)].

10. A modem according to claim 1, wherein:
said plurality of N−1 registers are implemented in one or more of FIFOs, shift-registers, circular buffers, and RAM.

11. A modem according to claim 1, further comprising:
a deinterleaver which receives interleaved codewords having said plurality of symbols and said given length, wherein said deinterleaver includes N registers for storing symbols of said interleaved codewords in parallel, a plurality of said N registers including a plurality of cells with each cell storing a symbol, and said interleaver further utilizing said indications of said permutation register in order to regenerate a deinterleaved codeword.

12. A modem according to claim 11, wherein:
the length LDⱼ of the j'th register of said N registers is determined according to LDⱼ=D−floor(j*D/N), j=0,1,2, . . . ,(N−1) where floor is a rounding down to the next whole number indication.

13. A modem according to claim 11, wherein:
each said regenerated deinterleaved codeword has N sequential symbols, and a first of said N sequential symbols is taken from a first delayed symbol of said interleaved codeword.

14. A modem according to claim 11, wherein:
each of said symbols is a byte.

15. A modem according to claim 11, wherein:
N is an odd number greater than five, and at least one of said plurality of N registers has a single cell, at least one of said plurality of N registers has two cells, and at least one of said plurality of N registers has three cells.

16. A modem according to claim 11, wherein:
said indications of said permutation register are set according to
f(n)=n_{ModN},
k(n)=(D−1)*f(n)+n,
m(n)=k(n)−N*(D−1),
where n=0,1,2, . . . ,(N*D−1), and Mod represents a modulus determination, and by setting indication f(n) into the m(n)'th cell of said permutation register when N*D>k(n)>N*(D−1).

17. A modem according to claim 11, wherein:
said indications of said permutation register are set according to a code comprising
for n=0 : 1 : (N*D − 1)
f=n-N*floor (n/N);
k=(D−1) *f + n;
if k>N* (D−1) and k<N*D
m=k-N* (D−1);
P(m) = f;
P(0) = 0
end
end
where
P is said permutation register, and floor is a rounding down to the next whole number indication.

18. A modem according to claim 11, wherein:
said plurality of said N registers uses a total number of deinterleaver memory cells m_{D}=(N−1)*[((D−1)/2)+1)]+D.

19. A modem according to claim 11, wherein:
said plurality of N registers are implemented in one or more of FIFOs, shift-registers, circular buffers, and RAM.

20. A modem, comprising:
a) a digital interface;
b) a transmitter coupled to said digital interface; and
c) a receiver coupled to said digital interface, said receiver including a deinterleaver which receives incoming interleaved codewords having a plurality of symbols and a given length, wherein said symbols were interleaved according to
dL(i)=(D−1)*i, i=0,1,2, . . . ,(N−1),
where dL(i) is the delay of the i'th symbol of a codeword, D is the interleaving depth, and N is said given length, and wherein
said deinterleaver includes N registers for storing symbols of an incoming codeword in parallel, a plurality of said N registers including a plurality of cells with each cell storing a symbol, and said deinterleaver further including a permutation register for storing indications of a static order in which symbols are either written into or read from said plurality of registers in order to generate a deinterleaved codeword.

21. A modem according to claim 20, wherein:
said permutation register includes N cells.

22. A modem according to claim 20, wherein:
the length LDⱼ of the j'th register of said N registers is determined according to LDⱼ=D−floor(j*D/N), j=0,1,2, . . . ,(N−1) where floor is a rounding down to the next whole number indication.

23. A modem according to claim 20, wherein:
each said regenerated deinterleaved codeword has N sequential symbols, and a first of said N sequential symbols is taken from a first delayed symbol of said interleaved codeword.

24. A modem according to claim 20, wherein:
N is an odd number greater than five, and at least one of said plurality of N registers has a single cell, at least one of said plurality of N registers has two cells, and at least one of said plurality of N registers has three cells.

25. A modem according to claim 20, wherein:
said plurality of said N registers uses a total number of deinterleaver memory cells m_{D}=(N−1)*[(D−1)/2)+1)]+D.

26. A modem according to claim 20, wherein:
said plurality of N registers are implemented in one or more of FIFOs, shift-registers, circular buffers, and RAM.

27. A method of interleaving codewords having a plurality of symbols and a given length N which are stored in a memory, said method comprising:
a) storing indications of a static order in which the symbols are to be written into or read from the memory in order to generate an outgoing interleaved codeword;
b) writing the codewords into the means with symbols of a given codeword located in parallel in the memory; and
c) reading the symbols out of the memory such that said symbols are distributed according to
dL(i)=(D−1)*i, i=0,1,2, . . . ,(N−1),
where dL(i) is the delay of the i'th symbol of an outgoing codeword, and D is the interleaving depth,
wherein one of said writing and said reading is done in said static order.

28. A method according to claim 27, wherein:
N is an odd number greater than five,
said memory includes N−1 registers, and
at least one of said N−1 registers has a single cell, at least one of said N−1 registers has two cells, and at least one of said N−1 registers has three cells.

29. A method according to claim 28, wherein the memory includes N−1 registers, said method further comprising:
determining the length Lⱼ of the j'th register of said N−1 registers according to Lⱼ=ceil(j*D/N), j=1,2, . . . ,(N−1), where ceil is a rounding-up to the next higher integer indication.

30. A method according to claim 27, further comprising:
determining said indications of said static order according to a code comprising
for n=0 : 1 : (N*D − 1)
f=n-N*floor (n/N);
k=(D−1) *f + n;
if k>N* (D−1) and k<N*D
m=k-N* (D−1);
P(m) = f;
end
end
where
P is a permutation register for storing said indications of a static order, and floor is a rounding down to the next whole number indication.

31. A method according to claim 27, further comprising: determining said indications of said static order according to
f(n)=n_{ModN},
k(n)=(D−1)*f(n)+n,
m(n)=k(n)−N*(D−1)
where n=0,1,2, . . . ,(N*D−1), and Mod represents a modulus determination, and
setting indication f(n) into the m(n)'th cell of a permutation register for storing said indications of a static order when N*D>k(n)>N*(D−1).

32. A method of deinterleaving interleaved codewords having a plurality of symbols and a given length N, said interleaved codewords having been distributed in the interleaved codewords according to
dL(i)=(D−1)*i, i=0,1,2, . . . ,(N−1),
where dL(i) is the delay of the i'th symbol of an outgoing codeword, and D is the interleaving depth, said method comprising:
a) storing indications of a static order in which the symbols of the interleaved codewords are to be written into or read from memory in order to generate an outgoing deinterleaved codeword;
b) writing the interleaved codewords into the memory with symbols of a given codeword located in parallel in the memory; and
c) reading the symbols out of the memory to generate deinterleaved codewords,
wherein one of said writing and said reading is done in said static order.

33. A method according to claim 32, wherein the memory has N registers, said method further comprising:
determining the length LDⱼ of the j'th register of said N registers is determined according to LDⱼ=D−floor(j*D/N), j=0,1,2, . . . ,(N−1), where floor is a rounding down to the next whole number indication.

34. A method according to claim 32, wherein:
the memory has N registers, and N is an odd number greater than five, and at least one of said N registers has a single cell, at least one of said N registers has two cells, and at least one of said N registers has three cells.
